(19) United States
(12) Patent Application Publication
(10) Pub. No.: US 2026/0290900 A1
(43) Pub. Date: Sep. 24, 2026

(54) Delocalized Designed Lithium-based Electrolyte and Preparation Method and Application thereof

(71) Applicant: Tianjin University, Tianjin (CN)

(72) Inventors: Wenbin HU, Tianjin (CN); Xiaopeng HAN, Tianjin (CN); He Huang, Tianjin (CN); Hao GUO, Tianjin (CN); Qiujiang Dong, Tianjin (CN); Yajun HOU, Tianjin (CN); Xingkai WANG, Tianjin (CN); Jinyang LI, Tianjin (CN)

(73) Assignee: Tianjin University, Tianjin (CN)

(21) Appl. No.: 19/578,788

(22) Filed: Mar. 25, 2026

Related U.S. Application Data
(63) Continuation of application No. PCT/CN2025/088028, filed on Apr. 9, 2025.

(30) Foreign Application Priority Data
Mar. 18, 2025 (CN) 202510320419.3

(51) Int. Cl. H01M 10/0568; H01M 10/0525

(52) U.S. Cl. CPC H01M 10/0568; H01M 10/0525; H01M 2300/0025

(57) ABSTRACT

The present invention discloses a delocalized designed lithium-based electrolyte that breaks through the structural limitations of conventional dominant solvents, and a preparation method and an application thereof. The delocalized electrolyte delocalizes its microscopic solvent structure by combining lithium salts and solvents with differentiated physicochemical properties, and further forms a diversified solvent structure. The solvent structure in the delocalized state not only enriches the microstructure of the electrolyte, but also significantly improves the overall electrolyte performance through performance complementation, thereby the charge and discharge efficiency and cycle life of the lithium battery are effectively improved. It is capable of realizing a lithium-based secondary battery of 600 Wh/kg or more by adopting the electrolyte, which has significant engineering application value.

### CROSS-REFERENCE TO RELATED APPLICATION

This application is a continuation of Chinese Patent Application No. 202510320419.3 filed on Mar. 18, 2025, the disclosure of which is hereby incorporated by reference in its entirety.

### TECHNICAL FIELD

The present invention belongs to the technical field of lithium battery and energy storage, relating to a lithium-based electrolyte, specifically to a lithium-based electrolyte which breaks through the structural limitations of conventional dominant solvents, and is suitable for the delocalized design of lithium battery, and preparation method and application thereof.

### BACKGROUND

The lithium battery is used as a key component in the energy storage technique currently, which is widely applied to the fields of electric automobile, renewable energy storage and portable electronic device, etc. By virtue of its high energy density and excellent circulation stability, the lithium battery has a core position in modern energy technology. However, with increasing demand for higher energy density and longer service life, conventional electrolyte design solutions have demonstrated significant limitations. The existing electrolyte system usually depends on the specific solvation structure, and the design of localized electrolyte usually faces problems of unstable performance, solvent degradation and battery efficiency reduction etc., when applied in the environment of high energy density and long cycle life.

In conventional electrolyte designs, the interaction between solvent and lithium salt typically determines the overall performance of electrolyte. The common design method mainly focuses on optimizing the selection of a single solvent or lithium salt and constructing solvent structure based on single main solvent or lithium salt. However, such design methods tend to be relatively strongly dependent, and are limited by the interaction of solvent and lithium salt, resulting in a gradual bottleneck in their performance in high voltage and high energy density environments. With the continuous increase of energy density of lithium battery, the performance bottleneck of the traditional electrolyte system under high voltage and high energy density is more prominent, especially under extreme working condition, the stability of electrolyte and the conductivity of lithium ion are difficult to be further optimized. This also leads to a rapid attenuation of the capacity of battery at high magnification or high voltage and a cyclic decay, which is a major challenge for high energy lithium battery currently. For embodiment, in recent years, a study has indicated that under high voltage (for embodiment, 4.5 V or more), conventional electrolytes tend to decompose or destabilize, resulting in rapid attenuation of the capacity of lithium metal battery, and even serious lithium precipitation problems, thereby the performance and safety of the battery are affected (Advanced Energy Materials, vol. 10, no. 12, 2020). In addition, the stability of conventional electrolytes under extreme temperature conditions is often insufficient, resulting in a severe reduction in battery life. As indicated by research, in high energy density batteries, due to insufficient strength of the interaction between solvent of electrolyte and lithium salt, the battery will have a significant decline in capacity after long-term use, especially there is a rapid decay phenomenon at high temperature or high voltage (Journal of Power Sources, vol. 439, 2019).

In order to address these challenges, research in recent years has attempted to improve the stability and ionic conductivity of the electrolyte by optimizing the combination of solvent and lithium salt. However, conventional electrolyte design methods are mostly focused on the optimization of a single solvent or lithium salt, ignoring the possible synergistic effect between different components. For embodiment, common used lithium salts such as LiPF6 and LiBF4 etc., are easily decomposed in a high voltage environment, resulting in a rapid decrease in electrolyte performance. Although some progress has been made in the research of “high stability” electrolytes in recent years, most of them are still limited to optimizing the solvent and salt of a single component (Journal of Power Sources, vol. 439, 2019). The limitation of these conventional design methods promotes the exploration of the novel electrolyte design concept.

To break through these bottlenecks, the present invention provides an innovative “delocalized designed” electrolyte which forms a complex and dynamic delocalized solvent structure by introducing a plurality of lithium salts and solvents having complementary physicochemical properties. The structure not only optimizes the micro solvent environment of the electrolyte, but also significantly improves the overall performance of the electrolyte, makes it show higher stability and longer cycle life in the application of high energy density, and solves the performance degradation problem of the existing electrolyte system under the condition of high voltage and extreme temperature.

### SUMMARY

The present invention provides a delocalized designed lithium-based electrolyte and preparation method and application thereof. The electrolyte breaks through the limitation dominated by the solvent in conventional electrolyte design by introducing multiple lithium salts and solvents with complementary physicochemical properties, and forms a complex and dynamic delocalized solvent structure. The structure not only optimizes the micro solvent environment of the electrolyte, but also significantly improves the overall performance of the electrolyte, makes it show higher stability and longer cycle life in the application of high energy density.

The object of the present invention is achieved by the following technical solution:

The present invention provides a delocalized designed lithium-based electrolyte, the electrolyte is obtained by artificial intelligent clustering analysis algorithm, the clustering method comprises one or more of K-means Clustering, Hierarchical Clustering, Density-Based Clustering (DBSCAN) and Gaussian Mixture Model (GMM). The method comprises the following steps:
Step 1, collecting at least 3 key physicochemical parameters which are related to a lithium salt and a solvent, and performing standardization processing on these data, so as to eliminate a dimension difference.
Step 2, performing cluster analysis on these standardized data through algorithm, dividing the lithium salt and solvent with similar physicochemical properties into different categories, the category is 2 or more.
Step 3, defining a required parameter, and through iterative adjustment, selecting a combination of lithium salt and solvent which is capable of maximizing a complementation of the physicochemical properties.
Step 4, preparing corresponding electrolyte according to a formulation.

The electrolyte of the present invention makes its micro solvent structure rich to delocalized state by selecting multiple lithium salts and solvents with physicochemical properties different from each other to be complementary. In the lithium-based electrolyte of the delocalized design, there are at least 10 kinds of solvation structures, the volume range of the solvation structure is 0.1 to 50 nm³, and the diameter distribution of the electrolyte solution micro-cluster is 0.5 to 100 nm.

As an embodiment of the present invention, the lithium salt and the solvent are optimally screened by clustering analysis, and the clustering indexes include the indexes of physicochemical properties such as oxidation-reduction potential, lithium ion binding energy, melting point and boiling point etc., but are not limited thereto. In some embodiments, the clustering indexes include the HOMO energy level, the LUMO energy level, and the lithium ion binding energy data of the lithium salt and the solvent.

As an embodiment of the present invention, the lithium salt and the solvent are optimized and screened by clustering analysis, so as to ensure that the oxidation-reduction potential of the selected lithium salt and solvent is more than or equal to 4V, a selection range of lithium ion binding energy is −4 to 10 eV, a selection range of melting point is −90 to 100° C., and a selection range of boiling point is 100 to 500° C.

As an embodiment of the present invention, the required parameter defined comprises 2 or more among lithium ion binding energy, electrolyte operating temperature range, species type of the lithium salt, species type of solvent, and solubility type of lithium salt. In some embodiments, the lithium ion binding energy range is defined to be −12 to −5 eV, the operating temperature range is −80 to 120° C., the species of the lithium salt is 5 types, the species of solvent is 5 types, and the solubility of lithium salt is >0.5 mol/L. In other embodiments, the binding energy of lithium ion is defined to be <6 eV, the operating temperature range is −60 to 150° C., the lithium salt species is 5 types, the solvent species is 5 types, and the lithium salt solubility is >0.5 mol/L.

As an embodiment of the present invention, the lithium-based electrolyte is composed of a lithium salt and a solvent, and the final concentration of the lithium salt is 0.5 to 5 mol/L; the type of the lithium salt is not less than 4, the mass of each lithium salt is more than 5% of the total mass of the lithium salt; the type of the solvent is not less than 4, and the volume of each solvent is 5% or more of the total volume of the solvent.

The lithium-based electrolyte can make the lithium metal battery full-cycle cycle without capacity sudden drop, until the slope is attenuated 10% capacity or less.

The adding amount of the lithium-based electrolyte is not more than 5 g/Ah according to the ratio of the mass of the electrolyte to the design capacity.

The lithium-based electrolyte makes the charging expansion volume of the lithium metal battery less than 10% per cycle.

The room-temperature ionic conductivity of the lithium-based electrolyte of the present invention is >3 mS/cm.

As an embodiment of the present invention, the electrolyte is prepared according to the formulation by a stepwise dissolution and precise temperature control process; during the dissolving process, the temperature is gradually adjusted, and the non-coordinating interaction is formed between the solvent and the lithium salt within 1 min through the temperature controlled solvation process, so as to achieve the delocalized solvation structure.

As an embodiment of the present invention, the lithium salt is added gradually; the change of temperature is adjusted according to the melting point of the added lithium salt: when the melting point of the lithium salt is relatively high, raising temperature to a temperature below the melting point (about 50 to 200 degrees centigrade); when the melting point of the lithium salt is relatively low, reducing temperature to a setting low temperature range (about 0 to 40 degrees centigrade); each time a new lithium salt is added, the temperature after mixing is changed within 1 min by the temperature controlled solvation.

As an embodiment of the present invention, a magnetic stirring and/or a ultrasonic oscillation are/is used in the dissolving process, the lithium salt is ensured to be evenly dissolved in a solvent in a temperature range of 0 to 100° C. The stirring time of the dissolving process is on the basis of the condition that the cascade reaction of the selected lithium salt and the solvent type does not happen, meanwhile, the precipitation phenomenon caused by excessive dissolving heat is not generated. The total stirring time is controlled at 2 to 4 hours to ensure a sufficient reaction of the lithium salt and the solvent.

In some embodiments, the method of preparing the delocalized lithium-based electrolyte comprises the following steps:
Step 1, selecting at least 4 lithium salts according to the algorithm of the present invention, wherein the mole mass of each lithium salt is 5% or more of the total mole mass of the lithium salt;
Step 2, selecting at least 4 solvents according to the algorithm of the present invention, wherein the volume of each solvent is 5% or more of the total volume of the solvent;
Step 3, using K-means algorithm, based on physicochemical properties such as oxidation-reduction potential, lithium ion binding energy, melting point, boiling point etc., screening and optimizing the selected lithium salt and solvent, ensuring the oxidation-reduction potential of the selected lithium salt and solvent is not less than 4V, the lithium ion binding energy selection range is −4 to −10 eV, the melting point selection range is −90 to 100° C., the boiling point selection range is 100 to 500° C.;
Step 4, mixing the optimally screened lithium salt and solvent, each time a new lithium salt is added, the temperature after mixing is changed within 1 min by temperature controlled solvation such that the optimally screened lithium salt and solvent are mixed, each time a new lithium salt is added, the temperature after mixing is changed within 1 min by temperature controlled solvation. The change of temperature is adjusted according to the melting point of the lithium salt: when the melting point of the lithium salt is relatively high, the temperature is raised to a temperature below the melting point so as to promote the solvation process; when the melting point of the lithium salt is relatively low, the temperature is reduced to a preset low temperature range so as to ensure that the solvation reaction is carried out at a proper temperature condition. Through the temperature control mode, the interaction between the solvent and the lithium salt can be effectively promoted, the solvent structure is optimized, and the performance and stability of the electrolyte are further improved.

As one embodiment of the present invention, the lithium salt according to Step 1 is at least 4 substances selected from the group consisting of lithium hexafluoroantimonate (LiSbF6), lithium hexafluorostannate (IV) (Li2SnF6), lithium hexafluorophosphate (LiPF6), lithium tetrafluoroborate (LiBF4), lithium hexafluorosilicate (F6Li2Si), lithium bis(fluorosulfonyl) imine (LiFSI), lithium (fluorosulfonyl) (trifluoromethanesulfonyl) imine (CF4LiNO4S2), 1,1,2,2,2,3,3-hexafluoropropene-1,3-disulfonimide lithium (C3F6LiNO4S2), bis (pentafluorovinylsulfonyl) imine lithium (C4F10LiNO4S2), bis (trifluoromethylsulfonyl) imine lithium (LiTFSI), nonafluoro-1-butenesulfonic acid lithium (C4F9LiO3S), lithium tetrachloroaluminate (LiAlC14), lithium perchlorate (LiC104), lithium difluorophosphate (LiPO2F2), lithium trifluoromethanesulfonate (LiOTf), lithium trifluoroacetate (CF3CO2Li), lithium metaphosphate (LiO3P), lithium tetrachloroplatinate (II) (Li2PdC14), lithium difluoro (oxalic acid) borate (LiDFOB), lithium 5-methyl-1,3,4-thiadiazole-2-carboxylate (C4H3LiN202S), lithium nitrite (LiNO2), lithium carbonate (Li2CO3), lithium chloride (LiCl), lithium iodoacetate (C2H2ILiO2), lithium dodecylsulfate (C12H25LiO4S), lithium bromide (LiBr), lithium monohydrogen phosphate (LiH2PO4), O-phosphoryl-L-homoserine lithium salt (C4H10NO6P), lithium sulfite (Li2SO3), lithium acrylate (C3H3LiO2), DL-lactic acid lithium salt (C3H503Li), L-lactic acid lithium salt (C3H5LiO3), 5-cyclopropyl-1,3,4-thiadiazole-2-carboxylic acid lithium salt (C6H5LiN203), D-allose acid lithium salt (C6H11LiO7), isobutyric acid lithium salt (C4H7LiO2), lithium acetate (C2H3LiO2), lithium 2-ethylhexanoate (C8H15LiO2), lithium 4-cyclohexyl butyrate (C10H17LiO2), lithium octoate (C8H15LiO2), lithium DL-2-hydroxybutyrate (C4H7LiO3), lithium D-(−)-citrate (C6H5Li307), lithium (R)-mevaroxate (C6H11LiO4), lithium benzoate (C7H5LiO2), lithium tartrate (C4H4Li2O6), lithium oxalate (C2O4Li2), monolithium 4-methoxypyridine-3-borate (C6H13BLiNO6), propofol-beta-D-glucuronic acid lithium salt (C18H25Li07), clavulanic acid lithium salt (C8H8LiNO5), p-toluene sulfonyl imide lithium (CH3C6H4SO2Li), salicylic acid lithium salt (C7H5LiO3), bis(nonafluorobutanesulfonyl) imine lithium (C8F18LiNO4S2), tetraphenyl lithium borate tri (1,2-dimethoxy ethylene) complex (C36H50BLiO6), 3-morpholine lithium propionate (C7H12LiNO3), lithium acetylacetonate (C5H7LiO2), 2,2,6,6-tetramethyl-3,5-heptenedione lithium (C11H19LiO2), cyclopentadienyl lithium (C5H5Li), ethylenediaminetetraacetic acid dilithium salt (C10H14Li2N2O8), lithium oxide (Li2O), lithium peroxide (Li2O2), lithium nitride (Li3N), lithium hexafluoroarsenate (V) (LiAsF6), lithium bis(oxalic acid) borate (LiBOB), lithium bis(oxalic acid) borate (LiBOB), lithium difluorophosphate (LiPO2F2), 4,5-dicyano-2-(trifluoromethyl) imidazole-1-sulfide (C6F3LiN4), tetraphenyllithium boron fluoride ether complex (C24BF2OLi), lithium metaborate (LiBO2), dilithium sulfopyruvate (C3H4Li2O6S), 2-oxo-2-(tetrafluorophosphate) lithium acetate (LiF4C2O4P), [1,2,4]triazole [4,3-a]pyrazine-3-carboxylic acid lithium salt (C6H3LiN402), 5-sulfoisophthalate monolithium salt (C8H5LiO7S), lithium acetate dihydrate (CH3COOLi), phenyl lithium solution (C6H5Li), lithium iodate (LiIO3), 5-bromopyridine-2-carboxylic acid lithium salt (C6H3BrLiNO), dihydroxy acetone phosphate lithium salt (C3H5Li2O6P), 3-fluoropyridine-2-carboxylic acid lithium salt (C6H3FLiNO2), DL-4-hydroxy-2-ketoglutaric acid dilithium salt (C5H4Li2O6), lithium acetoacetate (C4H5LiO3), adenosine 5′-O-sulphur single phosphate lithium salt (C10H12N5O6PSLi2), phenyl (2,4,6-trimethylphenyl) lithium phosphate (C16H16LiO3P), 6-hydroxy-chlorothioxanthene beta-D-glucuronic acid lithium salt (C13H11ClLiO9), lithium trimethylsilanolate (C3H9LiOSi), lithium phosphate (Li3PO4), 5-methylpyridine-2-boronic acid monolithium salt (C6H7BLiNO2), Profluoroxitin lithium salt (C24H31CILiNO4S), bis(trimethylsilyl) amine lithium (C6H18LiNSi2), (8-quinolinol) lithium (C9H6LiNO), 2-(2′,2″-bipyridin-6′-yl) phenol lithium salt (C16H11LiN2O), methyl lithium solution (CH3Li), isobutyl lithium (C4H9Li), hexa-lithium (C6H13Li), sec-butyl lithium solution (C4H9Li), ethyl lithium solution (CH3CH2Li), lithium sulfide (Li2S), tert-butyl lithium (C4H9Li), lithium diisopropylamide (C6H14LiN), lithium dicyclohexylamide ((C6H11) 2NLi), lithium diethylamino (C4H12LiN) and dimethyl amino lithium (C2H6LiN).

As an embodiment of the present invention, the solvent is at least 4 substance selected from the group consisting of amine carbonitrite (C2H2N20), 3-oxoacrylonitrile (C3H3NO), 1-fluoro-2-(methylsulfonyl)benzene (FS) (C7H7FO2S), methylbenzenesulfonate (C7H8O3S), propylene-1-en-1,3-cyclothiolactone (C3H403S), vinyl sulfinate (EVS) (C4H8O2S), N-cyanoformamide (C2H2N20), 3-oxobutenenitrile (C4H5NO), 2-oxo-1,3-dioxene-4-cyano (C4H3NO3), methyl-2,2,2-trifluoroethyl carbonate (TFEMC) (C4H5F303), ethylene sulfinic acid ester (ES) (C2H403S), methyl-2,2,2-trifluoroethyl carbonate (FEMC) (C4H5F303), propylene sulfinate (PS) (C3H6O3S), ethyl difluoroacetate (EDFA) (C4H6F2O2), fluoroacetonitrile (C2H2FN), trifluoroacetamide (C2H2F3NO), glycine nitrile (C2H3NO), cyanoacetic acid (C3H3NO), 3-cyanopropen-1-sulfonyl fluoride (CPSF) (C4H6FNO2S), acrylonitrile (MAN) (C3H2N2), chloromethylsulfonyl methane (C2H5C102S), methylsulfonyl fluoride (FMS) (CH3FO2S), pentanenitrile (GLN) (C5H6N2), 1,1,1-trifluoro-2-methylsulfonyl ethane (FEMS) (C3H5F302S), vinylidene fluoride carbonate (DFEC) (C3H2F2O3), methyl-2-cyano-2-methyl propionate (C6H9NO2), methyl-3,3,3-trifluoropropionate (TFPM) (C4H5F302), methyl (fluoromethyl) sulfinyl (C2H5FO2S), 3,3,3-trifluoroacrylonitrile (C3H2F3N), fluoroethylene carbonate (FEC) (C3H3FO3), nitrile malonic acid dinitrile (ADN) (C6H8N2), trifluoromethylsulfonylalkyl ethane (FMES) (C3H5F302S), pimelenitrile (PMN) (C7H10N2), ethyl-3,3,3-trifluoropropionate (TFPE) (C5H7F302), 1,1,1-trifluoro-3-(methylsulfonyl) propane (FPMS) (C4H7F302S), difluoro(methylsulfonyl) methane (DFSM) (C2H4F2O2S), 3-fluoro-1,3-propenolide (MESL) (C5H10O3S), propylene sulfamate (SEN) (C10H16N2), 1-(fluoromethyl)-1,3-dioxoxane (FPC) (C4H5FO3), bis(2,2,2-trifluoroethyl) carbonate (HFDEC) (C5H4F603), bis(2,2-trifluoroethyl) ether (BTFE) (C4H4F60), methylene nitrile (SUN) (C8H12N2), acrylonitrile (ACN) (C2H3N), meclonitrile (DMC) (C4H7N), mekgonitrile (PFPMC) (C5H5F503), trimethylacrylonitrile (C5H9N), pentenenitrile (C5H9N), 2,2-dimethylbutenenitrile (C6H11N), 1,1,2,2-tetrafluoroethyl-2,2,2-trifluoroethyl ether (HFE) (C4H2F80), ethyl-1,1,2,2-tetrafluoroethyl ether (ETFE) (C4H6F4O), 2,2-difluoroethyl ethyl carbonate (EDFEC) (C5H8F2O3), methyl-3,3,3-trifluoropropyl carbonate (TrFPMC) (C5H7F303), 1,1,2,2-tetrafluoro-3-(1,1,2,2-tetrafluoroethoxy) propane (FEPE/TTE) (C5H4F80), 4,4-difluoro-1,3-dioxane (C4H6F2O2), difluoro (dimethoxy) methane (C3H6F2O2), 2-oxo-1,3-dioxene-4-carboxylic acid (C4H405), trifluoro (methoxymethoxy) methane (C3H5F302), 4-trifluoromethyl-1,3-dioxan-2-one (TFPC) (C4H3F303), 1-fluoroethylmethylcarbonate (1FEMC) (C4H7FO3), 2,2-difluoroethylmethylcarbonate (DFEMC) (C4H6F2O3), 1,1,2,2-tetrafluoroethyl-2,2,2-trifluoroethyl ether (TFTFE) (C4H3F7O), 2-(methylsulfonyl)ethyl-2,2,2-trifluoropropionate (MSTFA) (C5H7F3O4S), 2-mesyl sulfonylethyl-2,2-difluoroacetic acid ester (MSPTFA) (C5H8F2O2S), methyl (methylsulfonyl) acetic acid ester (MMSA) (C4H8O4S), N,N-dimethyl benzene amide (C9H11NO), ethyl methyl sulfonyl acetate (EMSA) (C5H104S), chloroethanone (C3H5ClO), methoxyethanone (C4H8O2), ethyl-2-cyano-2-methyl propionate (C7H11NO2), ethyl-2-fluorosulfoethylcarbonate (EFSEC) (C5H9FO5S), butylethylketone (C7H14O), 2-fluoroacetamide (C2H4FNO), N-fluoromethyl-N-methylformamide (C3H6FNO), methylsulfonyl (methoxy) methane (MMMS) (C3H8O3S), 2-fluoro-N-methylacetamide (C3H6FNO), 2-(methylsulfonyl)ethylacetate (MSEA) (C5H10O4S), aminovalerolactone (DVL) (C5H8O2), diethyl sulfinate (DES) (C4H10O2S), ethyl isobutyl sulfinate (EiBS) (C6H1402S), dipropyl sulfinate (DPS) (C6H1402S), 3-methoxysulfinate (MESL) (C5H10O3S), 4,5-dimethyl-1,3-dioxane-2-one (C5H6O3), 1-(ethylenesulfinyl)-2-methoxyethane (EMES) (C5H12O3S), urea (CH4N20), methyl-3,3-difluoropropionate (C4H6F2O2), 3-methylsulfinane (3MESL) (C5H10O2S), 1-methoxy-2 (2-methoxyethanesulfonyl) ethane (DMES) (C6H1404S), carbohydrazide (CH4N20), methyl-3-fluoropropionate (C4H7FO2), ethyl isopropyl sulfinate (EiPS) (C5H12O2S), 2-methoxyacetamide (C3H7NO2), 2-(ethyl sulfonyl) butane (EsBS) (C6H1402S), 2-fluoro-N,N-dimethylacetamide (C4H8FNO), 2-methyl-1-(propylene-2-sulfinyl) propane (IPiBS) (C7H1602S), 2-(propylene-2-sulfinyl) butane (IPSBS) (C7H1602S), isopropyl methyl sulfinyl (MiPS) (C4H10O2S), methyl propyl sulfinyl (MPS) (C4H10O2S), tetraethylene sulfide (TMS/Sulfolane) (C4H8O2S), 3-isopropoxy tetrahydrothiane 1,1-dioxide (ISEL) (C7H14O3S), 3-ethoxysulfane (EESL) (C6H12O3S), 3-(2-methoxyethoxy) sulfane 1,1-dioxide (GLSL) (C7H1404S), methyl glycinate (C3H7NO2), 3-fluoropropionamide (C3H6FNO), isobutyramide (C4H9NO), propanamide (C3H7NO), acetamide (C2H5NO), dimethyl methyl phosphonate (DMMP) (C3H9PO3), butyrylamide (C4H9NO), N-methyl acetamide (NMA) (C3H7NO), 2-fluoroethyl acetate (2FEA) (C4H7FO2), N-ethyl formamide (C3H7NO), N-methyl-2-oxazolidinone (C4H7NO2), N, N-diethylacetamide (C6H13NO), N,N-dimethylacrylamide (C5H11NO), dimethylacetamide (DMA) (C4H9NO), 2-pyrrolidinone (C4H7NO), methoxymethoxyacetate (MMOA) (C4H8O3), dimethylsuboxide (DMSO) (C2H6OS), dimethyl formamide (DMF) (C3H7NO), 1-methyl imidazole (C4H6N2), N,N-dimethyl butyrylamide (C9H11NO), diethyl sulfinic oxide (DESO) (C4H10SO), N-methyl formamide (C2H5NO), trimethyl phosphate (TMP) (C3H9PO4), triethyl phosphate (TEP) (C6H15PO4), methyl methoxy acetate (MMOA) (C4H8O3), dipropyl sulfinic oxide (DPSO) (C6H14SO), 1-methyl-2-pyrrolidone (NMP) (C5H9NO), N-methyl pyrrolidone (C5H9NO), dibutylsulfinic oxide (DBSO) (C8H18OS), methoxy(methoxymethoxy) methane (C4H10O3), 1-ethoxy-2-(2,2,2-trifluoroethoxy) ethane (ETFEE) (C6H11F302), N,N′-dimethylimidazolidone (C5H10N20), ethyl fluoroethyl carbonate (EFEC) (C5H9FO3), 2-fluoro-propyl methyl carbonate (2FPMC) (C5H9FO3), 1,3-dioxan-2-amine (C4H9NO2), dimethoxymethane (DMM) (C3H8O2), diisopropyl ether (C6H14O), fluorine methoxy(methoxy) methane (C3H7FO2), ethylene thioamide (C2H5NS), 2-pyrrolidinyl thioketone (C4H7NS), dimethyl ketone (C3H6O), 3,4-difluorofuran (C4H2F2O), 2-butanone (methyl ethyl ketone) (C4H8O), 2,3-difluorofuran (C4H2F2O), methoxy benzene (C7H8O), 3-fluorofuran (C4H3FO), benzene ethoxy methane (C8H10O), butyl phenyl ether (C10H14O), proxybenzene (C9H12O), 2,4-difluorofuran (C4H2F2O), aminomethyl alkene (C3H9NO2), 2-fluorofuran (C4H3FO), 2,5-difluorofuran (C4H2F2O), furan (C4H40), 3-methoxy-furan (C5H6O2), 2-ethyl-furan (C6H8O), 1-(2,2,2-trifluoroethoxy)-2-methoxy-ethane (TFEME) (C5H9F303), 2-methoxy-furan (C5H6O2), methyl tert-butyl ether (C5H12O), 3-methyl tetrahydrofuran (C5H10O), 5-methoxy-1,3-dioxane (C5H10O3), cyclopentyl methyl ether (C6H12O), 1-(2,2-difluoroethoxy)-2-ethoxyethane (EDFEE) (C6H12F2O2), 2,3-dimethylfuran (C6H8O), 2-methyltetrahydrofuran (2-Me-THF) (C5H10O), 2-methyltetrahydrofuran (C5H10O), 4-methyl-1,3-dioxane (4ME13DOL) (C4H8O2), tetrahydrofuran (THF) (C4H8O), tetrahydropyran (C5H10O), tetrahydropyran (C5H10O), 1-(2-fluoroethoxy)-2-ethoxyethane (EFEE) (C6H13FO2), 1-(2-fluoroethoxy)-2-methoxyethane (FEME) (C5H11FO2), 2,5-dimethylfuran (C6H8O), dioxane (1,3-dioxane) (C3H6O2), 2-methyl-1,3-dioxane (2ME13DOL) (C4H8O2), 1-ethoxy-2-methoxyethane (EME) (C5H12O2), ethoxymethoxymethane (C4H10O2), triether (C8H18O4), diether (C6H14O3), diethyl ether (C4H10O), 1,2-diethoxyethane (DEE) (C6H1402), 1-ethoxy-2-methoxyethane (EME) (C5H12O2), 2-methyl-1,4-dioxanes (C5H10O2), 1,2-dimethoxyethane (DME) (C4H10O2), dioxanes (C4H8O2), aminoethanone (C3H7NO), 1,3-benzodioxane-2-one (C7H4O3), fluoroethanone (C3H5FO), pyridine (C5H5N), methyl fluorosulfonyl acetate (C3H5FO4S), methyl fluorosulfonyl acetate (MFSA) (C3H5FO4S), succinimide (C4H5NO2), benzyl nitrile (benzonitrile) (C8H7N), 2-fluorobutyryl lactone (FGBL) (C4H5FO2), N,N-dimethyl trifluoroacetamide (C4H6F3NO), vinyl acetate (C4H6O2), methyl cyanoacetate (MCA) (C4H5NO2), (methylsulfonyl) propyl acetate (MSPA) (C6H12O4S), amino acetyl nitrile (C2H4N2), 1,1-dioxathiane-3-yl acetate (ACSL) (C6H10O4S), ethyl cyanoacetate (ECA) (C5H7NO2), 1,1,1-trifluoro-2-methylsulfonyl propane (FIMS) (C4H7F3O2S), 1,1-dioxathiane-3-yl acetate (ECSL) (C7H12O5S), 4-(methylsulfonyl) butyronitrile (MCPS) (C5H9NO2S), ethylene carbonate (VC) (C3H2O3), 2-methylglutaronitrile (C6H8N2), fluoromethylpropionate (C4H7FO2), isobutylene carbonate (C5H8O3), 4-hydroxy-1,3-dioxan-2-one (C3H404), methylpropylcarbonate (MPC) (C5H10O3), methoxyacetonitrile (C3H5NO), 2-fluoro-ethyl methyl carbonate (MFEMC) (C4H7FO3), N-methoxyformamide (C2H5NO2), methyl formate (C2H4O2), ethyl-2-fluoropropionate (E2FP) (C5H9FO), dimethyl methanesulfonyl (DMS) (C2H6O2S), ([(2-methanesulfonyl ethoxy) carbonate]oxy) methane (MSEMC) (C5H10SO5), ethyl (3-(methylsulfonyl) propyl) carbonate (MSPEC) (C6H14SO5), thiophene, 3-fluorotetrahydrothiophene, 1,1-dioxide (3-FTMS) (C4H7FO2S), thiothiophene, 2-fluorotetrahydrothiophene, 1,1-dioxide (2-FTMS) (C4H7FO2S), ethyl [2-(methylsulfonyl)ethyl] carbonate (ethyl 2-mesyl ethyl carbonate) (MSDEC) (C6H12O5S), 2-([(3-mesyl sulfonyl propenyl) carbonate]oxy) propane (MSPiPC) (C7H16SO5), ethyl methyl sulfinyl (EMS) (C3H8O2S), 2-([(2-mesyl sulfonyl ethoxy) carbonate]oxy) propane (MSEiPC) (C7H1405S), 1,4-butanesultone (C4H8O3S), 1,3-propylene sultone (C3H6O3S), ethyl formate (C3H6O2), isobutyl formate (C5H10O2), ethyl fluoroacetate (EFA) (C4H7FO2), n-propyl formate (C4H8O2), thioxanane 1,1-dioxide (TriPS) (C3H6O2S), n-butyl formate (C5H10O2), 2-methyl thioxazane 1,1-dioxide (MTS) (C4H8O2S), Gamma-valerolactone (C5H8O2), isopropyl formate (C4H8O2), methyl (2-methoxyethyl) sulfinyl (MEMS) (C4H10O3S), propylene carbonate (PC) (C4H6O3), methoxypropionitrile (C4H7NO), 2,3-butene carbonate (C5H8O3), ethylene carbonate (EC) (C3H4O3), 1,2-butene carbonate (BC) (C5H8O3), amine carbonate (CH3NO2), 2-fluoroethyl propionate (2FEP) (C5H9FO2), fluoromethyl methyl carbonate (MFDMC) (C3H5FO3), Gamma-butyrolactone (GBL) (C4H6O2), dimethylcarbamic fluoride (C3H6FNO), formamide (CH3NO), methyl-2,2,3,3-tetrafluoropropyl carbonate (TeFPMC) (C5H6F4O3), 3-methoxypropionitrile (C4H7NO), 5-fluoro-1,3-dioxane (C4H7FO2), methyl carbamate (C2H5NO2), methyl isobutyrate (C5H10O2), 2-hydroxyethyl methyl carbonate (C4H8O4), butyl sultone (C8H18O3S), 2-methoxyethyl acetate (C5H10O3), 5,5-difluoro-1,3-dioxane (C4H6F2O2), isoamyl acetate (C7H1402), methyl acetate (MA) (C3H6O2), isopropyl acetate (C5H10O2), isobutyl acetate (C6H12O2), 1-methoxy-2-propyl acetate (MPA) (C6H12O3), methyl propionate (C4H8O2), ethyl acetate (EA) (C4H8O2), methyl butyrate (MB) (C5H10O2), 3-fluoropropylmethylcarbonate (FPMC) (C5H9FO3), 1-(2,2,2-trifluoroethoxy)-2-methoxyethane (C5H9F302), n-butyl acetate (C6H12O2), n-propyl acetate (C5H10O2), difluoro (methoxymethoxy) methane (C3H6F2O2), ethyl propionate (C5H10O2), ethyl butyrate (EB) (C6H12O2), fluorine (dimethoxy) methane (C3H7FO2), ethylpropylene-2-ethyl carbonate (EiPC) (C6H12O3), diethyl carbonate (DEC) (C5H10O3), methyl isopropyl carbonate (MiPC) (C5H10O3), ethyl methyl carbonate (EMC) (C4H8O3), dimethyl carbonate (DMC) (C3H6O3), 2-methoxy-1,3-dioxane (C5H10O3), ethyl propyl carbonate (EPC) (C6H12O3), 1,1-difluoro-2-(2-methoxyethoxy) ethane (DFEME) (C5H10F2O2) and di(fluoromethyl) carbonate (DFDMC) (C3H4F2O3) (as in embodiment 1, 2, the above listed lithium salts and solvents are subjected to cluster analysis, and the lithium salt and the solvent having similar physicochemical properties are classified into different categories).

The present invention further provides an application of the delocalized lithium-based electrolyte in preparing lithium battery. Wherein, the adding amount of the lithium-based electrolyte is not more than 5 g/Ah according to the ratio of the electrolyte mass to the battery design capacity. The lithium battery comprises a lithium ion battery, a lithium metal battery and a lithium sulphur battery.

The principle of the present invention is implemented by the following method:

Firstly, a lithium salt and a solvent suitable for delocalized electrolyte design are selected. To this end, the candidate solvent and lithium salt are classified and clustered in detail by systematic calculation and experiment method. The clustering method comprises K-means Clustering, Hierarchical Clustering, Density-Based Clustering (such as DBSCAN) and Gaussian Mixture Model (GMM) etc. Through these clustering methods, the candidate materials may be divided into several groups according to the physical and chemical characteristics of the solvent and lithium salt, such as polarity, solubility, ionization ability, stability etc., thereby the combination of lithium salt and solvent is ensured to form an ideal delocalized solvation structure in the electrolyte, so as to optimize the migration path of lithium ion, and improve the overall performance of the battery. The process aims to ensure that the final electrolyte not only has high ion conductivity and low battery internal resistance, but also has relatively wide electrochemical window to meet the requirement of high-efficiency battery. In the selection of lithium salts, the ionization ability and solubility thereof are first taken into consideration. Lithium salts having a relatively strong ionization tendency, such as lithium trifluoromethanesulfonyl trifluoride (LiTFSI), lithium hexafluorophosphate (LiPF₆) and lithium difluorooxalate borate (LiDFOB) etc., are preferred, these salts have relatively low electrical conductivity limits, and have relatively good solubility and relatively high chemical stability in solvents. However, there are a large amount of studies in which only these lithium salts have been selected, and the problems of poor cycle life and narrow operating temperature range (normal temperature of 20 to 30° C.) etc., that are commonly existed in lithium metal batteries cannot be solved in the common knowledge in the art, because it is relevant on the compatibility problem between the lithium salt domain solvents. Therefore, the compatibility between the lithium salt and the solvent is an important standard for screening. Desirable lithium salt should be capable of forming a stable solution with the selected solvent in a certain concentration range, without side reaction or precipitation, thereby ensuring long-term stability of the electrolyte in the use of the battery. On the selection of the solvent, it mainly depends on the polarity of the solvent, the chemical stability and the influence of the solvent on the dissolving ability of the lithium salt. Specifically, the selected solvent should have a relatively high polarity so as to better dissolve the lithium salt and support ion conduction. Meanwhile, the stability of the solvent is critical to the long-term use of the electrolyte, especially under high voltage operation. To this end, fluorinated solvents such as fluoroethylene carbonate (FEC) and difluoroethylene carbonate (DFEC) etc., are considered as the main candidate solvent, but these two common known solvents are well in stability and meanwhile low in the dissociation degree to lithium salt, in order to achieve the delocalized structure, accordingly it is necessary to rescreen and match by means of artificial intelligence, the highest occupied molecular orbital (HOMO), the lowest unoccupied molecular orbital (LUMO), and the lithium ion binding energy (Binding energy) are three key indicators for the rescreened combination.

Secondly, preparing delocalized electrolyte solution, specifically by selecting at least four lithium salts, the mass of each lithium salt is 5% or more of the total mass of the lithium salt, and at least four solvents are selected, the volume of each solvent is 5% or more of the total volume of the solvent. The lithium salt and the solvent are selected by the clustering analysis method, and the physicochemical properties thereof are ensured complementary, so as to optimize the performance of the electrolyte solution. The types of the selected lithium salt include LiTFSI, LiPF₆, LiDFOB, and the like, but are not limited thereto, these lithium salts have relatively high ionization ability and good compatibility with the solvent. The mass of each lithium salt is 5% or more of the total mass, so as to ensure sufficient ionic conductivity. The types of the selected solvent include fluorosolvents (e.g., FEC, DFEC), carbonate-based solvents (e.g., EC, DMC), and the like, which have different polarities, solubility, and solubilization ability to lithium salts, and act synergistically in the electrolyte to form a stable solvation structure. The preparation process applies a process of gradual dissolution and precise temperature control, so as to ensure that an ideal delocalized solvation structure is formed between the lithium salt and the solvent, and the stirring time cannot be too long, because the delocalized structure may collapse due to the cascade reaction of the selected lithium salt and the solvent type, for example, LiDFOB preferentially dissociates DFEC to generate BF3 and disrupts the delocalized structure, therefore it is necessary to avoid stirring similar species for excessive time at high temperatures as far as possible. Firstly, the lithium salt and the solvent are mixed according to the required ratio, and since some lithium salts are not dissolved at low temperature, the lithium salt is ensured to be uniformly dissolved in the solvent in the temperature range of 0 to 100° C. by using the magnetic stirring and ultrasonic oscillation technology. The stirring time is controlled at 2 to 4 hours to ensure a sufficient reaction of the lithium salt and the solvent and also avoid damaging the overall delocalized structure. The temperature and stirring time of the dissolving process are precisely controlled, and it is also necessary to prevent the precipitation phenomenon caused by excessive dissolving heat, and the uniformity and stability of the solution are ensured.

Finally, in order to realize the formation of the delocalized solvation characteristic, the present invention adopts the “temperature controlled solvation” technique. In this process, the gradual establishment of the non-coordinating interaction between the solvent and the lithium salt molecule is ensured by gradually cooling or heating the solution, adjusting the concentration and the solvation process thereof. As the temperature changes, the strength of the interaction between the solvent and the lithium salt is effectively adjusted, thereby promoting the formation of a structure having delocalized solvation characteristics. The structure has relatively high degree of freedom, which effectively avoids the limitation of the lithium ion migration in the conventional solvation structure, so that the lithium ion can be more freely migrated in the electrolyte solution so as to improve the conductivity of the electrolyte solution and the performance of the battery.

Finally, the prepared delocalized electrolyte solution is applied to the high-energy lithium battery system, and the performance in the actual battery environment thereof is evaluated, especially in the charging and discharging process of the long period, the generation of the lithium dendritic crystal is effectively inhibited, the internal resistance of the battery is maintained as relatively low and the circulation stability is maintained well.

The delocalized electrolyte design of the present invention and the application in the lithium battery thereof have the following significant beneficial effects:
1) Improving the conductivity of lithium ion: by introducing a plurality of lithium salts and solvents with complementary properties, the solvation structure of the electrolyte is optimized, and the free migration ability of lithium ions in the electrolyte solution is enhanced, thereby the ionic conductivity of the electrolyte solution is effectively improved, which may be more than 3 mS/cm.
2) Prolonging the cycle life of the battery, the delocalized electrolyte solution is adopted such that the generation of lithium dendritic crystal of the battery in the long-term charging and discharging process can be inhibited, thereby the instability of the lithium metal deposition is reduced, so as to improve the circulation stability and service life of the battery, such that the charging volume expansion of the battery is less than 10% per cycle.
3) Widening the electrochemical window: through reasonable combination of solvent and lithium salt, the delocalized electrolyte solution of the present invention has relatively wide electrochemical window, may operate stably in the high voltage interval (such as 4.0V to 6.5V), significantly improves the energy density of the battery, and is suitable for the development of the high energy density battery.
4) Enhancing the safety of the battery: due to the unique solvation structure and low reactivity of the delocalized electrolyte solution, the occurrence of solvent degradation and side reaction can be inhibited effectively, and the safety of the battery under extreme conditions such as high voltage and long-term cycle etc., can be improved, and it is implemented that there is no capacity sudden reduction in the full cycle of the lithium metal battery, instead, it is reduced gradually to 10% or less of the initial capacity.
5) Multi-functionalized electrolyte solution system: the electrolyte solution system designed by the present invention may adjust the ratio of the solvent and the lithium salt flexibly according to different requirements, so as to adapt to different types of lithium batteries, and have good applicability and scalability, is able to meet the diverse needs of high-performance lithium batteries.
6) The electrolyte is applicable for the high-performance lithium battery, it is able to improve the charging and discharging efficiency, circulation stability and safety of the lithium battery effectively, and has excellent performance, especially in the design of soft-packed battery in the environment of high voltage and high energy density. Compared with conventional electrolyte, the electrolyte of the present invention has wider applicability and provides breakthrough application value in the battery technology.

### BRIEF DESCRIPTION OF THE DRAWINGS

Other features, objects and advantages of the present invention will become more apparent from the following detailed description of non-limiting embodiments with reference to the accompanying drawings:

FIG. 1 is the result of K-means Cluster analysis of the solvent of emodiment1;

FIG. 2 is a comparison of solvation structures of electrolytes with different delocalized degrees;

FIG. 3 is a comparison of the cycle performance of the button cell of the electrolyte solutions with different delocalized degrees in the 1C charge/discharge cycle test of the 4.3V Ni90/4.6V LCO cell;

FIG. 4 is a comparison of cycle performance of 500 Wh/kg soft-packed batteries of electrolyte solutions of different delocalized degrees;

FIG. 5 is a comparison of cycle performance of 600 Wh/kg soft-packed batteries of electrolyte solutions of different delocalized degrees.

### DETAILED DESCRIPTION

The present invention will be described in detail below with reference to embodiments. The following embodiments will help those skilled in the art to further understand the present invention, but are not intended to limit the present invention in any form. It should be noted that, for those of ordinary skill in the art, any modifications and improvements may be made without departing from the spirit of the present invention. All these belong to the protection scope of the present invention.

### Emodiment1

Adopting K-means Clustering analysis method, screening according to the following steps.

Step one, collecting key physicochemical parameters related to lithium salt and solvent, directly searching by means of material database (such as Materials Project, NIST Chemistry WebBook etc.), or using theoretical calculation software (such as VASP, Gaussian etc.) for density functional theory (DFT) calculation to obtain these data, such as taking the highest occupied molecular orbital (HOMO), the lowest unoccupied molecular orbital (LUMO) and lithium ion binding energy as 3 key indicators, and these data were standardized to eliminate dimensional differences.

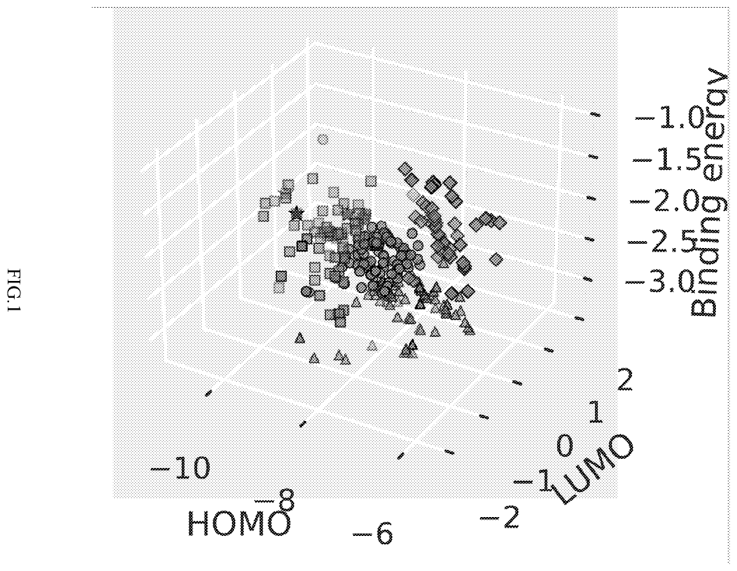

Step two, adopting K-means Clustering analysis algorithm to perform clustering analysis on the standardized data. Firstly, the HOMO energy level, LUMO energy level and lithium ion binding energy data of the lithium salt and the solvent were collected and normalized to eliminate dimensional differences. Then, the normalized data point was mapped to a three-dimensional Euclidean space, wherein the three-dimensional coordinates of each data point correspond to the normalized values of HOMO energy level, LUMO energy level and lithium ion binding energy thereof, respectively. By K-means Clustering analysis, four clustering centres were first randomly initialized, and the Euclidean distances of all data points to these centres were calculated, and each data point was classified to the nearest clustering centre. Then, calculating the average value of the data point in each class, and iteratively updating the clustering centre until convergence. Finally, the K-means algorithm divided the lithium salt and the solvent into four types according to the distribution mode of the data points in the three-dimensional space, such that the material in the same class with similar characteristics in aspects of HOMO, LUMO and lithium ion binding energy, and each class was represented by a sphere of different colours, as shown in FIG. 1.

Step three, the lithium ion binding energy range was limited to −12 to −5 eV, the operating temperature region was-80 to 120° C., the lithium salt species was 5 types, the solvent species was 5 types, the lithium salt solubility was more than 0.5 mol/L, through iterative adjustment, the combinations of lithium salts and solvents that are capable of maximizing the complementations of physicochemical properties were finally selected, as shown in Table 1.

TABLE 1
Electrolyte solution formulation of Emodiment1

| lithium salt | molar ratio | solvent | volume ratio |
|---|---|---|---|
| C6F3LiN4 | 0.2 M | FEC | 0.2 V |
| LiBO2 | 0.2 M | FEMC | 0.2 V |
| LiDFOB | 0.2 M | DFEC | 0.2 V |
| LiPF⁶ | 0.2 M | 1FEMC | 0.2 V |
| LiPO2F2 | 0.2 M | DFEMC | 0.2 V |

The electrolyte solution formulation as shown in Table 1 had an oxidation-reduction potential of not less than 6.0 V, a lithium ion binding energy of −7.38 eV, a melting point of −83° C., and a boiling point of 136° C.

Step four, mixing the optimally screened lithium salt and solvent to prepare the electrolyte. The preparation process comprises the following steps: firstly, weighing the lithium salt according to the ratio, and dissolving in the solvent, ensuring the concentration of each lithium salt is 0.2M, meanwhile, ensuring the uniformity of the solvent proportion; then, a method which combines magnetic stirring and ultrasonic oscillation was applied to stir for 3 hours (including temperature change time) at a temperature range of 0-70° C. to ensure that the lithium salt was completely dissolved; during the dissolving process, the temperature was gradually adjusted, and the solvent and the lithium salt form a non-coordinating interaction within 1 min by the temperature-controlled solvation process so as to realize the delocalized solvation structure. Specifically, firstly FEC, FEMC, DFEC, 1FEMC, DFEMC were stirred at normal temperature according to ratios of Table 1 for 1 h, then the temperature was raised to 100° C., and LiBO2 was added according to the formulation of Table 1 and stirred for 1 min to completely dissolve; then the temperature was reduced to 80° C., and LiPO2F2 was added according to the formulation of Table 1 and stirred for 1 min to completely dissolve; then the temperature was reduced to 65° C., and LiDFOB was added according to the formulation of Table 1 and stirred for 1 min to completely dissolve; then the temperature was reduced to 40° C., and LiPF6 was added according to the formulation of Table 1 and stirred for 1 min to completely dissolve; finally the temperature was reduced to 25° C., and C6F3LiN4 was added and finally stirred for 1 min to obtain a typical delocalized electrolyte solution.

### Emodiment2

Adopting K-means Clustering analysis method, screening according to the following steps.

Step one, collecting key physicochemical parameters related to lithium salt and the solvent, taking the highest occupied molecular orbital (HOMO), the lowest unoccupied molecular orbital (LUMO) and lithium ion binding energy as 3 key indicators, and these data are standardized to eliminate dimensional differences.

Step two, adopting K-means Clustering analysis algorithm to perform clustering analysis on the standardized data, the lithium salts and solvents with similar physicochemical properties were divided into 4 categories (substantially the same as Step two of emodiment1).

Step three, the lithium ion binding energy was limited to be less than 6 eV, the operating temperature region was-60 to 150° C., the lithium salt species was 5 types, the solvent species was 5 types, the lithium salt solubility was more than 0.5 mol/L, through iterative adjustment, the combinations of 5 lithium salts and 5 solvents selected from the candidate lithium salts and solvents were shown in Table 2.

TABLE 2
Electrolyte solution formulation of embodiment 2

| lithium salt | molar ratio | solvent | volume ratio |
|---|---|---|---|
| LiPF₆ | 0.2 M | FEC | 0.2 V |
| LiBF₄ | 0.2 M | FEMC | 0.2 V |
| LiDFOB | 0.2 M | DFEC | 0.2 V |
| LITFSI | 0.2 M | 1FEMC | 0.2 V |
| LiOTf | 0.2 M | TTE | 0.2 V |

According to the electrolyte solution formulation in Table 2, the oxidation-reduction potential was measured to be not less than 5.5 V, the lithium ion binding energy was-6.77 eV, the melting point was −66° C., and the boiling point was 216° C.

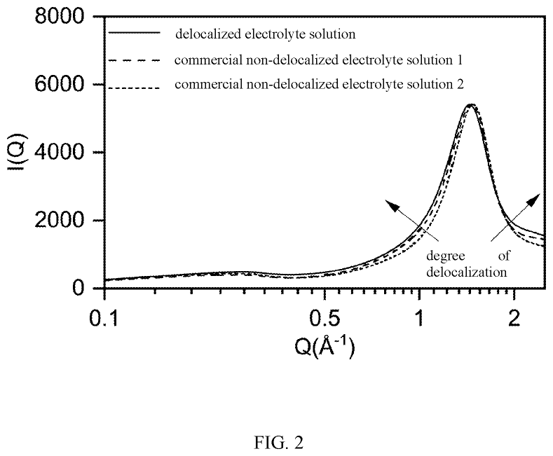

Step four, mixing the optimally screened lithium salt and solvent to prepare the electrolyte. The preparation process comprises the following steps: firstly, weighing the lithium salt according to the ratio, and dissolving in proper amount of solvent, ensuring the concentration of each lithium salt was 0.2M, meanwhile, ensuring the uniformity of the solvent proportion; then, a method which combines magnetic stirring and ultrasonic oscillation is applied to stir for 2 hours (including temperature change time) at a temperature range of 25-100° C. to ensure that the lithium salt was completely dissolved; during the dissolving process, the temperature was gradually adjusted, and the solvent and the lithium salt is formed a non-coordinating interaction within 1 min by the temperature-controlled solvation process so as to realize the delocalized solvation structure. Specifically, firstly FEC, FEMC, DFEC, 1FEMC were stirred at normal temperature according to ratios of Table 2 for 1 h, then the temperature was raised to 70° C., and LiOTf was added according to the formulation of Table 2 and stirred for 1 min to completely dissolve; then the temperature was reduced to 60° C., and LiBF4 was added according to the formulation of Table 2 and stirred for 1 min to completely dissolve; then the temperature is reduced to 0° C., and TTE solvent was added according to the formulation of Table 2 and fully stirred for 1 h, then the temperature was kept, LiTFSI was added and stirred for 1 min to completely dissolve; then the temperature was raised to 50° C., LiDFOB was added according to the formulation of Table 2 and stirred for 1 min to completely dissolve; finally the temperature was reduced to 25° C., and LiPF₆ was added and finally stirred for 1 min to obtain a typical delocalized electrolyte solution. As shown in FIG. 2, compared with other two types of non-delocalized commercial electrolyte solutions, that is, commercial type 1:1 mol/L LiPF₆ EC/EMC (1:1 volume ratio) and commercial type 2:1 mol/L LiPF₆ FEC/FEMC (1:1 volume ratio), the delocalized electrolyte solution designed in this embodiment shows the widest solvation structure range in the Small Angle Scattering Spectrum, corresponding to the delocalized solvation structure inside the electrolyte solution.

### Application Embodiment 1

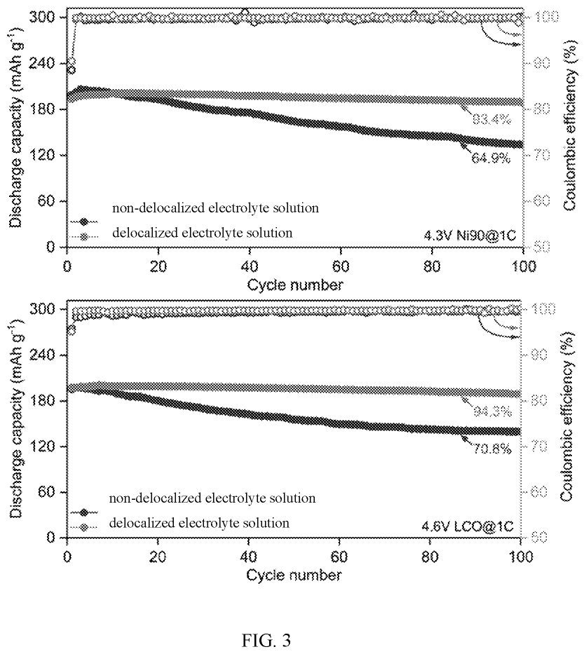

The delocalized electrolyte solution prepared in embodiment 1 was applied to the test of lithium metal button cells, as shown in FIG. 2. 4.3 V High nickel positive electrode Ni90 (LiNi_{0.9}Co_{0.05}Mn_{0.05}O2) ∥ lithium metal negative electrode (Li) and 4.6V high voltage lithium cobaltate positive electrode LCO (LiCoO₂) ∥ Li button type battery are adopted for cycle performance test. In the 1C charge and discharge cycle test of the 4.3V Ni90 battery, as shown in FIG. 3, the delocalized electrolyte solution shows excellent circulation stability, and the capacity retention rate after 100 cycles was as high as 93.4%. In contrast, the capacity retention rate of the non-delocalized electrolyte solution under the same condition was only 64.9%. Similarly, in the 1C charge/discharge cycle test of 4.6 VLCO battery, as shown in FIG. 3, the delocalized electrolyte shows a relatively high initial discharge capacity and maintains a capacity retention rate of 94.3% after 100 cycles, and the capacity retention rate of the commercial type 2 non-delocalized electrolyte solution was 70.8%.

### Application Embodiment 2

The delocalized electrolyte solution prepared in embodiment 2 was adopted for the test of the lithium metal soft-packed battery, and the specific design parameters of the lithium metal soft-packed battery were shown in Tables 3 and 4.

TABLE 3
Design parameters of 500 Wh/kg level lithium metal soft-packed
battery of Application embodiment 2

| Battery module | Specifications | Parameters |
|---|---|---|
| negative electrode | thickness (μm) | 50.0 |
| (lithium foil) | | |
| electrolyte solution | injection volume (g /Ah) | 1.6 |
| membrane (alumina- | thickness (μm) | 17.0 |
| coated PE) | | |
| positive electrode (4.45 V- | load amount (mg/cm2) | 31.8 |
| NCM811) | | |
| package (aluminum-plastic | size (mm × mm × mm) | 42 × 30 ×5.9 |
| shell) | | |
| battery overall parameters | discharge capacity (Ah) | 1.8 (0.5 C) |
| | specific energy (Wh/kg) | 510.1 (0.5 C) |
| | total weight (g) | 14.03 |

TABLE 4
Design parameter of 600Wh/kg level lithium metal soft-packed
battery of Application embodiment 2

| Battery module | Specifications | Parameters |
|---|---|---|
| negative electrode | thickness (μm) | 50.0 |
| (lithium foil) | | |
| electrolyte solution | injection volume | 1.0 |
| | (g/Ah) | |
| membrane | thickness (μm) | 5.0 |
| (alumina-coated PE) | | |
| positive electrode | load amount (mg/cm2) | 38.0 |
| (4.3 V-Ni90) | | |
| package (aluminum- | size (mm × mm × mm) | 90 × 50 × 5.1 |
| plastic shell) | | |
| battery overall | discharge capacity | 5.5 (0.2 C) |
| | (Ah) | |
| parameters | specific energy (Wh/kg) | 604.2 (0.2 C) |
| | total weight (g) | 34.93 |

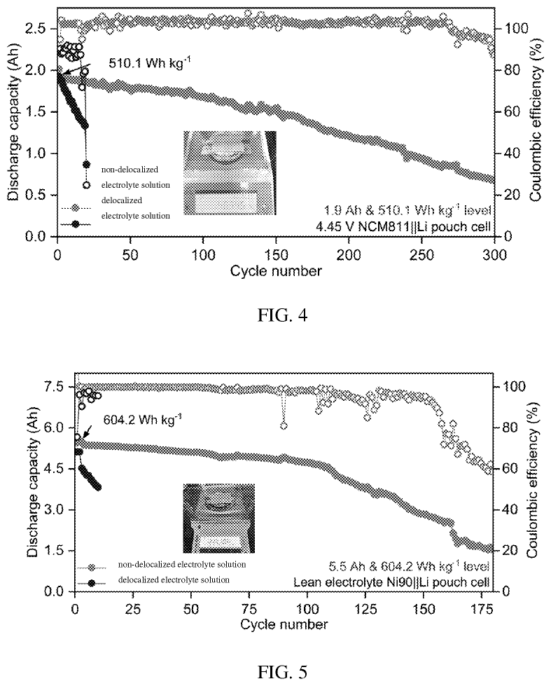

As shown in FIGS. 4, as to 500 Wh/kg level lithium metal soft-packed battery, in room temperature environment, 0.2 C rate charging and 0.5 C rate discharging was adopted to perform a constant current charging and discharging test of cycle performance test, the electrolyte solution for testing was the delocalized electrolyte prepared in the embodiment 2 and the non-delocalized electrolyte solution of the commercial type 1, the voltage range was 2.8V to 4.3V, and the discharge capacity and energy density after each cycle were recorded; the cycle was continued until 300 times, the capacity attenuation condition was observed. The test results of the lithium metal soft-packed battery showed that the 1.9 Ah lithium metal soft-packed battery of the delocalized electrolyte prepared in embodiment 2 achieved an energy density up to 510.1 Wh/kg, and the energy density was maintained at 404.1 Wh/kg after 150 cycles at 0.5 C rate, and no obvious capacity decay was appeared after 300 cycles. This level of durability is not achievable with existing lithium metal soft-packed batteries with poor electrolyte solution and meets the goal of the Battery 500 program of the United States.

As shown in FIGS. 5, as to 600 Wh/kg level lithium metal soft-packed battery, in room temperature environment, 0.2 C rate charging and 0.25° C. rate discharging was adopted to perform a constant current charging and discharging test, the electrolyte solution for testing was the delocalized electrolyte solution prepared in embodiment 2 and the non-delocalized electrolyte solution of commercial type 1, the voltage range was 2.8V to 4.3V, and the discharge capacity and energy density after each cycle were recorded; the 5.5 Ah lithium metal soft-packed battery adopting the delocalized electrolyte solution prepared in embodiment 2 also showed excellent performance, with an energy density of 604.2 Wh/kg and still maintained an energy density of 517.7 Wh/kg after 100 cycles, and no obvious polarization phenomenon was observed in the long-cycle process, which breaks through the significant point of the Battery 600.

### Comparative Embodiment 1

The electrolyte solution of the embodiment 1 of the grant invention CN113782810B (wherein 71% of the main solvent (DMC, MMA), 26% of the fluorinated solvent (FEC, TFEB), 3% of the self-sacrificing revulsant (AIBN, TTE) and 1.5 mol/L of lithium salt (LATP, LiPF₆)), 7Ah level designed soft package battery (calculated by 4.45V theoretical value of positive electrode). The commercial LCO was taken as the positive electrode, the metal lithium was taken as the negative electrode, the commercial celgard 2325 was taken as the membrane, so as to form the electric core, the adding amount of the electrolyte solution is that E/C ratio equal to 1.2 g/Ah, the composed soft-packed battery was aged for 24 h at 45° C. and then vacuum sealed to obtain the sample battery; the sample battery is charged to 4.45V at 0.1 C, the fluctuation curve of the self-sacrifice charging voltage appeared at 4.2V, the discharge cut-off voltage of 0.1 C was 3V, cycled for 5 times, the actual discharge capacity of the soft-packed battery was 7.53 Ah, the average specific energy was 433 Wh/kg; then, the sample battery was charged to 4.6V at 0.3 C, the discharge cutoff voltage at 0.3 C was 3 V, the actual discharge capacity of the soft-packed battery was 9.35 Ah, the initial discharge specific energy was 539 Wh/kg, and the discharge specific energy at the 100th cycle was 460.8 Wh/kg.

In the application of high energy density, the delocalized electrolyte solution is capable of stably running and keeping relatively long service life. Of particular note is the low liquid injection amount of the delocalized electrolyte solution, in the present test, the liquid injection amount of the electrolyte solution of the battery was controlled at 1.5 g/Ah, this design of low liquid injection amount not only effectively reduces the use amount of the electrolyte solution, but also further optimizes the overall energy density of the battery. The low liquid injection amount is capable of reducing the volume of the electrolyte solution inside the battery, such that the energy density of the lithium metal battery is effectively improved, meanwhile, the excellent circulation stability and relatively low internal resistance are maintained, compared with the initial non-circulation state, the volume expansion thereof was only 9.3% by means of the thickness measuring instrument.

In summary, the present invention provides an innovative design of delocalized electrolyte solution to break through the performance bottlenecks of conventional electrolyte solutions in lithium batteries, especially challenges in terms of high energy density and long circulation stability. The delocalized electrolyte of the present invention makes the micro-solvent structure realize delocalized by combining the lithium salt and the solvent with differential physicochemical properties so as to form diversified solvent structures. The solvent structure in the delocalized state not only enriches the microstructure of the electrolyte, but also significantly improves the performance of the overall electrolyte through the performance complementation so as to effectively improve the charging and discharging efficiency and the cycle life of the lithium battery. More specifically, the present invention combines the artificial intelligent clustering analysis algorithm to accurately select a plurality of lithium salts and solvents, and a ratio of lithium salt and solvent with complementary physicochemical properties is adopted, thereby the solvation structure is optimized, the conductivity of lithium ion and the stability of the battery are significantly improved, it exhibits excellent performance especially in high voltage and high energy density applications.

The application of the delocalized electrolyte solution of the present invention in the battery has significant innovativeness and utility. Firstly, by precisely controlling the combination of the solvent and the lithium salt of the electrolyte solution, it breaks through the limitation of the conventional solvation structure, thereby a solvation structure which is more free and dynamic is formed, which not only improves the ion conductivity of the battery, but also effectively inhibits the generation of the lithium dendritic crystal so as to improve the safety and circulation stability of the battery. secondly, the design of the low liquid injection amount of the delocalized electrolyte effectively reduces the use amount of the electrolyte solution, the energy density of the battery is extremely improved, and a novel technical solution for the development of the next generation of high energy density lithium battery is provided.

In addition, the delocalized electrolyte has wide applicability in various lithium battery types, especially in the lithium metal soft-packed battery, with the improvement in the electrochemical window of the electrolyte solution, the enhancement of the lithium ion migration efficiency, and the inhibition of side reaction, the electrolyte solution of the present invention significantly improves the energy density and the service life of the battery and promotes the further development of the high-performance battery technology.

Therefore, the delocalized electrolyte solution of the present invention not only has innovativeness in theory, but also has extremely high utility in practical application, and is capable of providing reliable solution for lithium battery with high performance, long service life and low liquid injection amount, and has wide market prospect and application value.

The specific embodiment of the present invention is described as above. It should be understood that the present invention is not limited to the specific embodiments described above, and those skilled in the art may make various variations or modifications within the scope of the appended Claims without departing from the spirit of the present invention.

What is claimed is:

1. A delocalized designed lithium-based electrolyte, wherein the lithium-based electrolyte is composed of a lithium salt and a solvent, a final concentration of the lithium salt is 0.5 to 5 mol/L; a type of the lithium salt is not less than 4, a mass of each lithium salt is 5% or more of a total mass of the lithium salt; a type of the solvent is not less than 4, and a volume of each solvent is 5% or more of a total volume of the solvent,
wherein the electrolyte is obtained by an artificial intelligent clustering analysis algorithm, the clustering method comprises one or more of K-means Clustering, Hierarchical Clustering, Density-Based Clustering and Gaussian Mixture Model; the method comprises following steps:
S1, collecting at least 3 key physicochemical parameters which are related to a lithium salt and a solvent, and performing standardization processing on these data, so as to eliminate a dimension difference;
S2, performing cluster analysis on these standardized data through the algorithm, dividing the lithium salt and the solvent with similar physicochemical properties into different categories, the category is 2 or more;
S3, defining a required parameter, and through iterative adjustment, selecting a combination of the lithium salt and the solvent which is capable of maximizing a complementation of the physicochemical properties, wherein the required parameter defined comprises 2 or more among lithium ion binding energy, electrolyte solution operating temperature range, lithium salt species type, solvent species type and lithium salt solubility type; and
S4, preparing corresponding electrolyte according to a formulation.

2. The delocalized designed lithium-based electrolyte according to claim 1, wherein the lithium salt and the solvent are optimally selected by clustering analysis, and a clustering index includes oxidation-reduction potential, lithium ion binding energy, melting point and boiling point.

3. The delocalized designed lithium-based electrolyte according to claim 2, wherein the oxidation-reduction potential of the selected lithium salt and solvent is ensured to be more than or equal to 4V, the selection range of lithium ion binding energy is −4 to 10 eV, a selection range of the melting point is −90 to 100° C., a selection range of the boiling point is 100 to 500° C.

4. The delocalized designed lithium-based electrolyte according to claim 1, wherein the electrolyte is prepared according to the formulation by gradually dissolving and precise temperature control process; the temperature is gradually adjusted during the dissolving process, and a non-coordinating interaction is formed between the solvent and the lithium salt within 1 min through a temperature controlled solvation process, so as to achieve a delocalized solvation structure.

5. The delocalized designed lithium-based electrolyte according to claim 4, wherein the lithium salt is added gradually; a change of temperature is adjusted according to the melting point of the added lithium salt; when the melting point of the lithium salt is relatively high, raising temperature to a temperature below the melting point; when the melting point of the lithium salt is relatively low, reducing temperature to a setting low temperature range; each time a new lithium salt is added, the temperature after mixing is changed within 1 min by the temperature controlled solvation.

6. The delocalized designed lithium-based electrolyte according to claim 4, wherein a magnetic stirring and/or a ultrasonic oscillation are/is used in the dissolving process, the lithium salt is ensured to be evenly dissolved in the solvent in a temperature range of 0 to 100° C.

7. An application of the delocalized designed lithium-based electrolyte according to claim 1 in preparing a lithium battery, wherein the adding amount of the lithium-based electrolyte is not more than 5 g/Ah according to the ratio of the mass of the electrolyte and a design capacity of the battery.

8. The application according to claim 7, wherein the lithium battery comprises a lithium ion battery, a lithium metal battery and a lithium sulphur battery.
